(19) United States
(12) Patent Application Publication
(10) Pub. No.: US 2014/0353295 A1
(43) Pub. Date: Dec. 4, 2014

(54) SYSTEM, METHOD AND APPARATUS FOR REMOVING A BURR FROM A SLOTTED PIPE

(71) Applicant: REGENT TECHNOLOGIES LIMITED, NISKU (CA)

(72) Inventor: Michael CLAERHOUT, Nisku (CA)

(21) Appl. No.: 13/904,907

(22) Filed: May 29, 2013

(51) Int. Cl. B23K 26/36; B23K 26/06; B23K 26/067

(52) U.S. Cl. CPC B23K 26/36; B23K 26/067; B23K 26/0626
USPC 219/121.62; 219/121.78; 219/121.77; 219/121.76; 219/121.61

(57) ABSTRACT

A deburring system for removing burrs from a surface of a pipe is provided. The deburring system comprises: a shaft having an anterior end; a conduit contained in the shaft for carrying a laser beam generated from a laser; and a directing module to direct the laser beam emanating from the conduit radially from the shaft to the surface of the pipe. The deburring system is shaped to fit inside the pipe.

### FIELD OF DISCLOSURE

The disclosure describes a system, method and apparatus for resurfacing an interior surface of a hollow structure, for example, for removing burrs from a surface of a slotted pipe used as a liner in an oil and gas well.

### BACKGROUND OF DISCLOSURE

In tar sands and heavy oil recovery for horizontal well bores, in situ sand control for oil recovery is typically provided in part with a sand control screen that holds back mobilized debris and keeps mobilized debris of certain sizes from entering the well bore and being produced to surface.

One sand control screen is a slotted liner, which is a pipe is typically installed in a well bore. The slotted liner has multiple longitudinal slots about its circumference formed in the pipe prior to its insertion into a well bore. A desired length and width of the slots perforated in the pipe and a desired number of slots depend upon various factors, including the granular size of any sand in the formation, the minimum strength and integrity of the pipe required for the particular application or use of the pipe and the rate of the oil/sand influx into the pipe from outside the pipe.

In forming the slots with a circular saw blade, the blade tends to leave jagged burrs or tendril-like “wickers” where the slots intercept the interior surface of the pipe. These burrs and wickers are undesirable as they may affect the flow of materials through the pipe. As such, when producing a slotted liner, the wickers are preferably removed.

One removal method is to send a “stinger” device through the slotted liner. The stinger has multiple rotating blades disposed to scrape the interior perimeter of the liner as the stinger passes through it. The rotating blades are meant to cut off the wickers, which can then be removed from the liner by compressed air or other means. However the scraping blades tend to bend the wickers and push them back across or into the slots, causing a reduction in the open slot area available for passage of oil into the liner. This problem is particularly evident for slot widths of about 1 mm (0.04 inches) and less. As such, the effective slot area tends to become further reduced when the liner is placed in service, because foreign materials entering the slots build up on the bent-back wickers, causing the slots to become partially or totally plugged. Other mechanical methods, such as honing or burnishing, have been used in an attempt to polish down the wickers. However, these methods have similar drawbacks, as they tend to brush at least some of the wicker back into the slots.

In addition to the foregoing problems, wickers or any other material left inside slotted liners may damage or interfere with expensive down-hole tools used in well-servicing operations.

There is a need for wicker-removal and de-burring apparatus and methods that can remove burrs and wickers from slotted liners that with greater effectiveness than known apparatus and methods.

### BRIEF DESCRIPTION OF THE DRAWINGS

Embodiments of the disclosure will now be described, by way of example only, with reference to the accompanying drawings, in which:

FIG. 1A is a perspective view of a schematic of a slotted pipe for use in oil or gas wells that is treatable by a deburring system according to an embodiment;

FIG. 1B is an end view of a schematic of the pipe of FIG. 1A;

FIG. 2A is a perspective view of a schematic of a part of the deburring system according to an embodiment for use with the pipe of FIG. 1A;

FIG. 2B is an end view of a schematic of a part of the deburring system of FIG. 2A;

FIG. 2C is a perspective skeletal view of a schematic of the part of the deburring system of FIG. 2A;

FIG. 2D is a perspective skeletal view of a schematic of an alternative part of the deburring system of FIG. 2A;

FIG. 3A is a perspective view of a schematic of the part of the slotted liner of FIG. 1A being treated by a front end of the deburring system according to an embodiment of FIG. 2A;

FIG. 3B is an end view of a schematic of the part of the pipe of FIGS. 1A and 3A being treated by the deburring system according to an embodiment of FIGS. 2A and 3A;

FIG. 4 is a schematic diagram of a deburring system for treating a pipe of FIG. 1A according to an embodiment; and

FIG. 5 is a flow chart of an exemplary method for deburring a pipe according to an embodiment.

### DESCRIPTION OF EMBODIMENTS

Exemplary details of embodiments are provided herein. The description that follows and the embodiments described therein are provided by way of illustration of an example or examples of particular embodiments of principles of the present disclosure. These examples are provided for the purposes of explanation and not limitation of those principles and of the disclosure. In the description that follows like parts are marked throughout the specification and the drawings with the same respective reference numerals.

Briefly, an embodiment provides a device, system, apparatus and method whereby burrs inside a slotted liner are removed by exposure to a directed energy source, such as a laser, for a sufficient length of time to effectively oxidize or incinerate the burrs.

In a first aspect, a deburring system for removing burrs from a surface of a pipe is provided. The deburring system comprises: a shaft having an anterior end; a conduit contained in the shaft for carrying a laser beam generated from a laser; and a directing module to direct the laser beam emanating from the conduit radially from the shaft to the surface of the pipe. The deburring system is shaped to fit inside the pipe.

The deburring system may further comprise a collar located around the shaft to allow the shaft to rotate about a longitudinal axis of the collar relative to the collar.

In the deburring system, the collar may comprise a set of skates located on a radial surface of the collar.

In the deburring system the directing module may be incorporated into the shaft.

In the deburring system, the directing module may further comprise a first mirror to redirect a path of the laser beam emitted from the deburring system.

In the deburring system, the first mirror may split the laser beam into a plurality of laser beams; and each of the plurality of laser beams may be directed to different locations on the surface of the pipe.

In the deburring system, the first mirror may be angled to redirect the path of the laser beam to contact an interior wall of the pipe at a first angle between approximately 1 and 45 degrees from the radius of the pipe.

The deburring system may further comprise a second mirror to redirect a path of a second laser beam emitted from the deburring system to contact the interior wall of the pipe at a second angle between approximately 1 and 45 degrees from the radius of the pipe.

In the deburring system, the first and second mirrors may be directed to locate the first and second lasers to simultaneously debur different sides of an opening in the interior wall of the pipe.

The deburring system may further comprise a control module to modulate the power and duration of the laser beam.

In the deburring system, the control module may be responsive to data relating to a temperature of the pipe to modulate the power and duration of the laser beam.

In the deburring system, the temperature may relate to a temperature on an exterior surface of the pipe.

In the deburring system, the temperature may relate to a temperature in an interior of the pipe.

The deburring system may further comprise a cleaning system attached to a blower to direct air out of a port in the deburring system to remove remnants of the burrs from the surface of the pipe.

The deburring system may further comprise a feedback system to provide data on a location and temperatures within the pipe at a current location deburring system within the pipe.

The deburring system may further comprise a control system to activation commands to the laser and orientation commands to the directing module following an expected pattern of slots for a location within the pipe.

In a second aspect, a method of removing burrs from a surface of a pipe is provided. The method comprises: positioning a deburring system having a laser at a first location within the pipe; positioning a directing module to direct a laser beam from the laser at a second location on an interior wall of the pipe; activating the laser for a preset amount of time; and positioning the deburring system at a third location within the pipe. For the method, the deburring system has: a shaft having an anterior end; and a conduit contained in the shaft for carrying the laser beam generated from the laser. Also the directing module directs the laser beam emanating from the conduit radially from the shaft to the surface of the pipe.

In other aspects, various combinations of sets and subsets of the above aspects are provided.

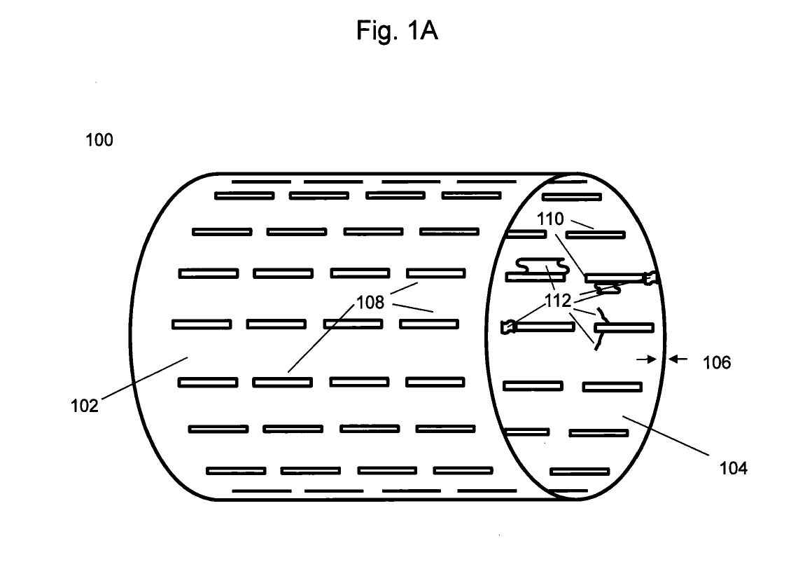

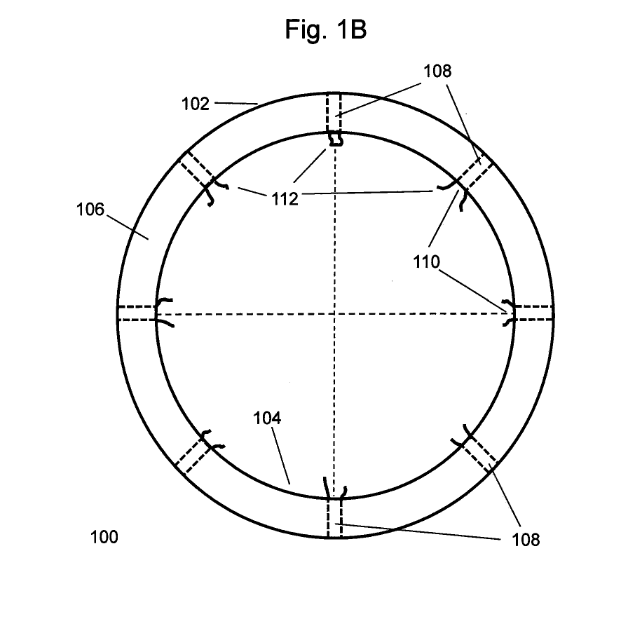

Now general features of an embodiment are described. FIGS. 1A and 1B illustrate slotted pipe 100 that may be used as a liner in a well bore. Pipe 100 may be made of any material, such as an alloy of steel, which may be hardened and pipe 100 may be for any industrial, commercial or residential purpose. In one embodiment, pipe 100 is an oil country tubular goods (OCTG) pipe, which is typically manufactured in one of several methods, such as:
a continuous mandrel-rolling process and a push bench process for a pipe having an OD from approximately between 21 mm (approximately 0.8 inch) and 178 mm (approximately 7 inches);
a plug mill rolling process for a pipe having an OD of approximately between 140 mm (approximately 5 inches) and 406 mm (approximately 16.0 inches); or
a cross-roll piercing and pilger rolling process for a pipe having an OD of approximately between 250 mm (approximately 9.8 inches) and 660 mm (approximately 26.0 inches).
   An exemplary length for pipe 100 in a well bore is in the range of approximately 3 m long (approx. 9.8 feet) or less to approximately 15 m long (approx. 49.2 feet) or more. It may be of various thicknesses and sizes. Such pipes are frequently used in high stress environments and are typically exposed to simultaneous stresses from, for example, torque by drilling, axial tension from dead weight of the pipe itself and internal pressure from excavation of drilling fluid from the inside of the pipe. Heat treating the pipe may be used to strengthen the pipe. An alloy for the pipe typically contains chromium and magnesium. In other embodiments a pipe may be made of plastic or thermoplastic material, concrete, ceramic or other materials known to a person of skill in the art.

Pipe 100 has exterior surface 102 and interior surface 104. Between exterior surface 102 and the proximate interior surface 104 is wall 106. A plurality of slots 108 are provided along the length of pipe 100, where the slots are located on exterior surface 102 and extended through wall 106 to interior surface 104. Slots 108 form openings 110 on interior surface 104. Pipe 100 is generally cylindrical, but may have other cross sectional shapes (e.g. square, ovoid, etc.). In a typical well bore installation, materials located on the outside of pipe 100 are received into pipe 100 via the slots. The materials entering pipe 100 are screened by the size and shapes of the slots. Pipe 100 may be inserted into a well bore in the ground having a generally vertical section, connected to a heel portion, connected to a generally horizontal portion having a toe portion (not shown). Pipe 100 may be inserted in the well bore and be positioned at any section along the length of the well bore. A typical location is either in a vertical section or a horizontal section of the well bore. In other embodiments, pipe 100 may be located in other environments (e.g. in water or another liquid, in air, in a particulate environment (e.g. a grain hopper), etc.). Pipe 100 is generally cylindrical, but may have in any part any cross-section shape (e.g. square, rectangular, oval, hexagonal, polygon, etc.) having a wall that defines an interior space on one side and an exterior space on another side of the wall. The wall may be closed onto itself (e.g. as a cylinder) or not (e.g. as a trough).

When slot 108 is cut with a mechanical rotary saw blade, a rectangular shaped slot with differing dimensions on exterior surface 102 compared to interior surface 104 is formed. A width of slot 108 coincides with the saw blade width, while the outside slot length coincides with the radius of the blade and the depth in which the blade plunges into the wall of the pipe. For wells installed in formations containing fine-grained materials, liner slot width may need to be as narrow as approximately 1.0 millimeter (0.04 inches) or even considerably less. The slots may be of any convenient length, but they are typically in the range of approximately 75 mm to 100 mm (3 to 4 inches) long. They are typically provided in a uniform spacing about the circumference of the pipe, for example at radial intervals as low as 5 degrees. Slots 108 are oriented parallel to a longitudinal axis of pipe 100, but in other variations of slotted pipe 100, slots 108 may be oriented transversely or obliquely relative to the axis of pipe 100. Features of pipe 100 shown in FIGS. 1A and 1B are not to scale.

When the saw blade is plunged into pipe 100, the blade typically creates a rounded slot bottom prior to breaking through into interior surface 104 of pipe 100. As the saw blade continues inward through the pipe, the material immediately below the blade gets progressively thinner until it can no longer provide enough resistance to the inward force of the blade. At that point the blade forces the remaining pipe material to plastically deform such that as the blade continues to move inward, the material elongates to its ultimate yield strength and finally fractures. If the fracture happens on the up-milling side of interior opening 110, material may be plastically displaced from the edge of the opening inward into the interior of pipe 100. The material may be displaced on a longitudinal edge and/or a side edge of opening 110.

Part of fractured material may form burrs 112 on the edges of openings 110. For the sake of convenience and not limitation the term “burr” is used herein to refer to any burrs, wickers, ejecta, filaments, flashings or other extraneous material located around and/or attached around openings 110. Such burrs may be formed during creation of slot 108 or during other processes in the forming or shaping of pipe 100 and/or its slots 108. As shown, a burr 112 may be created on a longitudinal edge and/or a side edge of opening 110.

With some configurations and dimensions of pipe 100 with slots 108 and burrs 112 described, further details of a device, system and method for removing such burrs 112 from pipe 100 according to an embodiment are now provided.

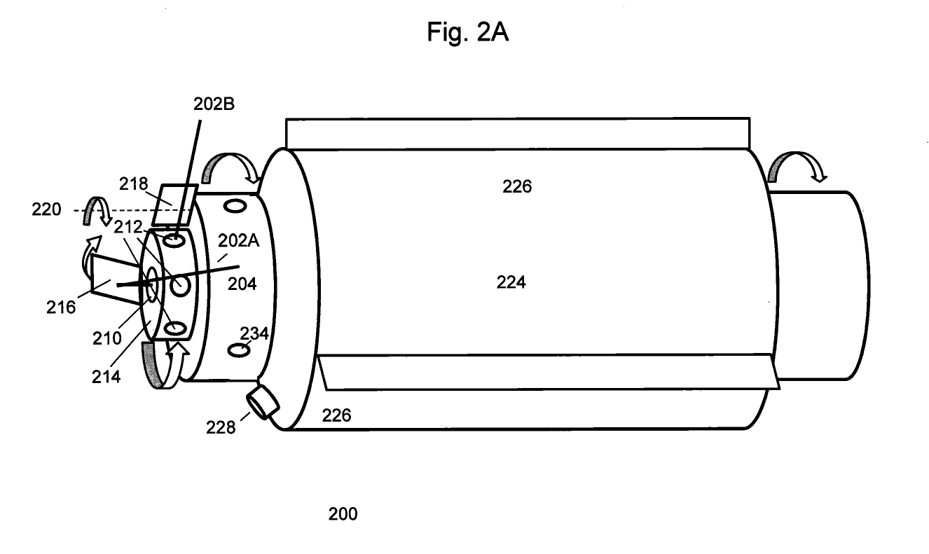

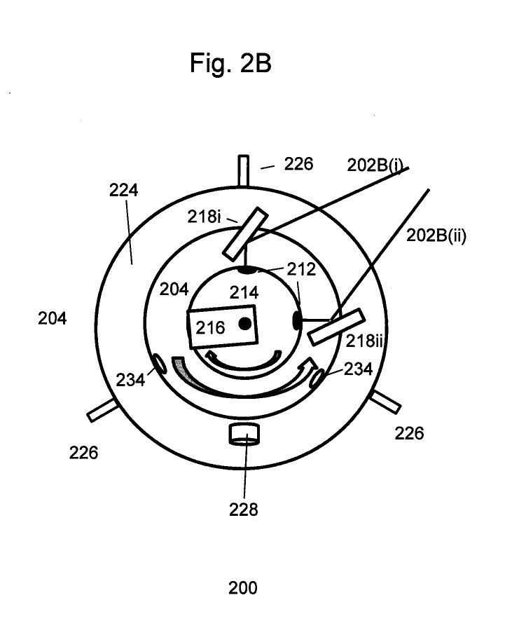

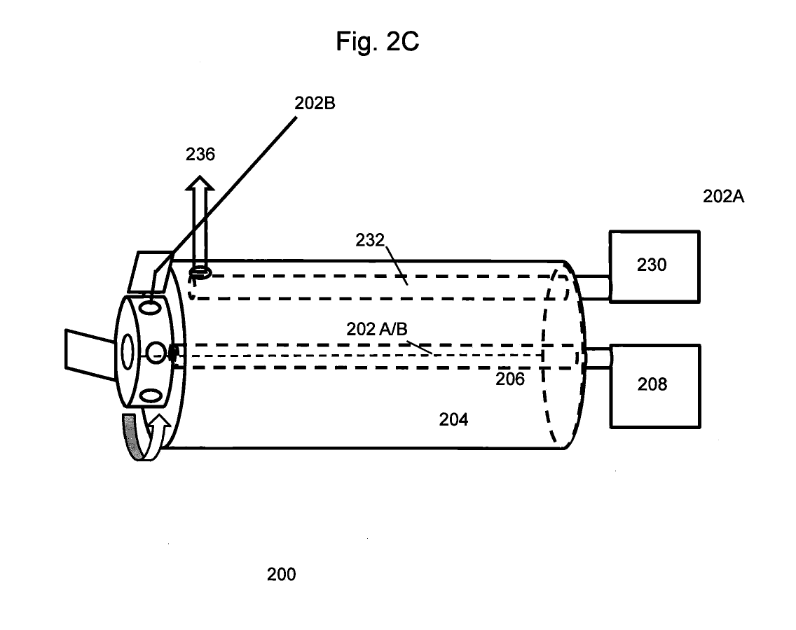

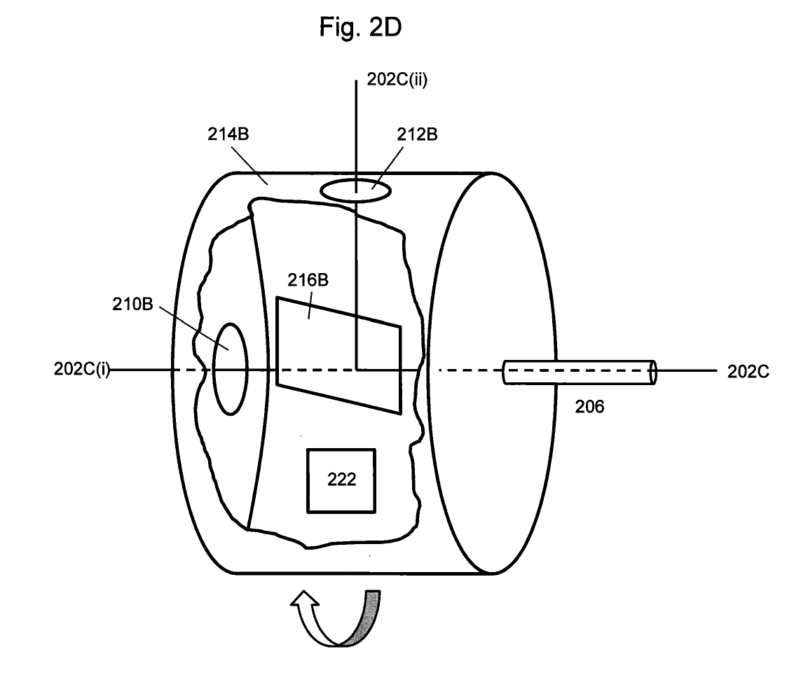

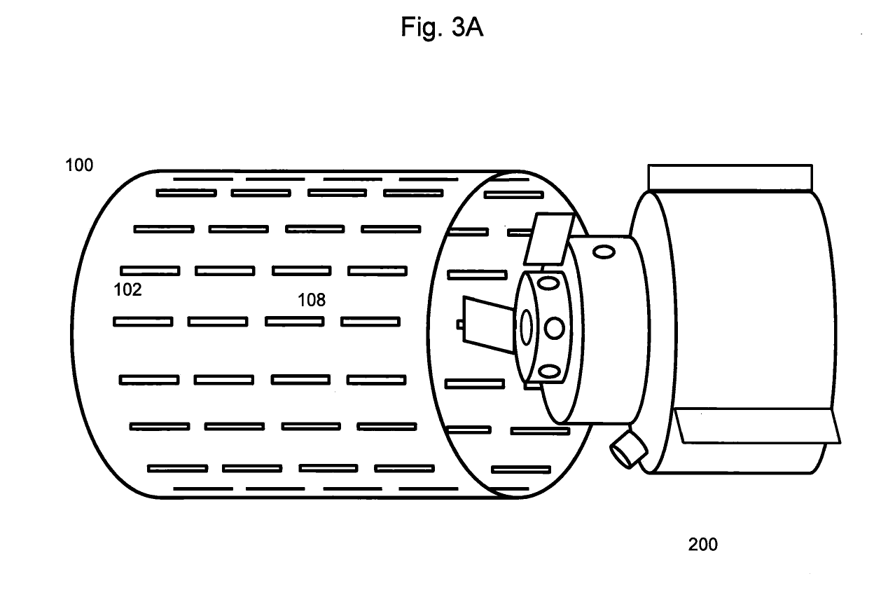

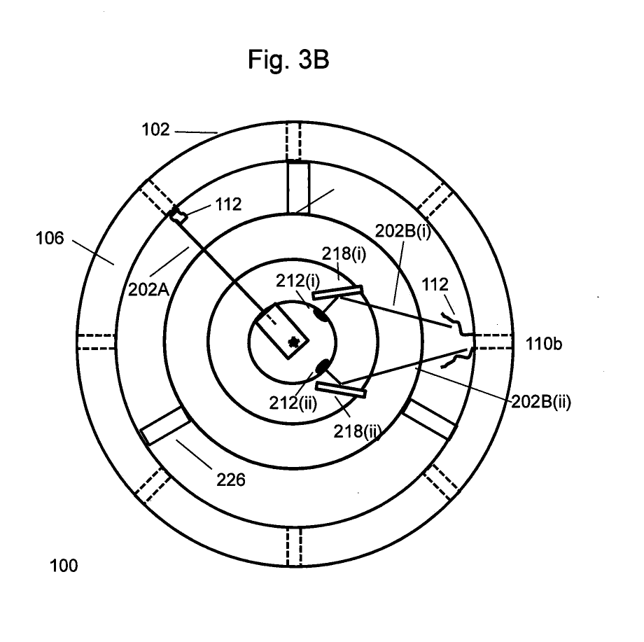

FIGS. 2A-2C show features of exemplary deburring system implementing features of an embodiment. FIG. 2D shows an alternative feature of the deburring system of an embodiment. FIGS. 3A and 3B show the deburring system in use in a pipe. Features shown in FIGS. 2A-2D and 3A and 3B are not to scale.

Generally, an embodiment provides deburring system 200 that can direct a heat source into a target, such as to interior surface 104 of pipe 100, to remove artefacts, such as burrs 112, therefrom. The heat source may be provided as a focussed beam of energy, such as from a laser (i.e. from a source providing light amplification by stimulated emitted radiation) or other directable energy source. A laser is an optical device that emits coherent light through optical amplification of a light source. A laser is a class of maser. For the sake of convenience and not limitation the term “deburring system” herein is used to refer to a system, device and/or parts thereof that removes artefacts, such as burrs 112, from a surface of an object, such as from interior surface 104 of pipe 100 per an embodiment.

Laser 208 may be a gas laser, chemical laser or solid state laser, such as a laser diode. The power of existing lasers range from approximately 1 mW to more than 3000 W. The output of laser 208 may be continuous or pulsed. For example, to heat a metallic surface (such as copper) for a pipe, it has been determined that for a laser the temperature rise at the surface of the metal is dependent on the time of exposure of the metal to the laser, the thermal conductivity, the density and the heat capacity of the metal. In one embodiment, multiple lasers 208 may be provided, where the lasers 208 are different devices, have different wavelengths and/or power outputs. The actual wavelength of the laser beam may or may not be a significant factor in the heating time for pipe 100.

For a type of steel frequently used in slotted pipes, effective use of deburring system 200 typically needs heating of burrs 112 to temperatures in approximately at least 3310° C. (approximately 6000° F.). When applying laser beams 202 to pipe 100, it is preferable that the temperature of the main body of pipe 100 does not become excessive, in order to prevent undesirable metallurgical changes in the parent metal. Use of laser beams 202A, 202B assists in regulating the temperature in pipe 100 as laser beams 202A, 202B are focussed, directed beams of energy, thereby reducing the amount of wasted energy that would heat the ambient air in pipe 100 and adjacent regions around opening 110.

Deburring system 200 comprises several components that are fitted/attached together to carry laser beam 202 to its intended target on surface 104. In one configuration, the main structural component of deburring system 200 is shaft 204 which has one or more internal channels 206 to carry one or more laser beams 202 emitted from one or more lasers 208 to directing module 214, which is located at an anterior end of shaft 204 (i.e. the front end of deburring system 200). When shaft 204 is solid (or solid in parts internally), channels 206 provide internal openings that generally run along the length of shaft 204. Also located in directing module 214 are axial opening 210 and a plurality of radial openings 212. One channel 206 may run along the longitudinal axis of shaft 204. Openings 210 and 212 are connected to an anterior end of channel 206. Openings 210 and 212 may be covered with a lens. Opening 210 is aligned in the axial center of deburring system 200. Openings 212 are located on radial surface of directing module 214. A channel 206 may contain a fibre optic cable (not shown) to carry laser beam 202 from laser 208 to openings 210, 212. Multiple lasers 208 may be associated with one channel 206. In such a configuration, separate lasers 208 may be activated at different times and different orientations of mirrors 216 and/or 218 may be initiated to direct laser beam 202 for a particular laser 208 being carried through channel 206 to a specific target location for pipe 100 at a given instance. Separate additional channels (not shown) may be provided for one or more openings 212 and/or for different lasers 208. If shaft 204 is hollow, channels 206 may be foregone. In one embodiment opening 210 or openings 212 may be left out. In one configuration it is preferable to have axial openings 212 as the deburring will occur along the sides of pipe 100 as system 200 is inserted into pipe 100. As an exemplary configuration, system 200 may be between approximately 0.30 m to 1.23 m (1 to 4 feet) in length and may have a circumference shaped to fit within pipe 100 fairly snugly, but with enough room to be moved within pipe 100.

In the preferred embodiment, deburring system 200 is fabricated at least in part from steel. In an alternative embodiment, the torch head is fabricated at least in part from a metal (such as titanium) that can withstand higher temperatures than steel without undesirable metallurgical or other effects.

Directing module 214 has one or more mirrors 216, 218 which can be rotated and/or move into different positions relative to openings 210 and 212 to change (or not change) an outbound direction a path of laser beams 202A, 202B that are emanating from deburring system 200 to be aimed at locations on interior surface 104 of pipe 100. Mirror 216 is located on directing module 214. Mirrors 218 are located on an anterior end of shaft 204 and are rotatable about offset longitudinal axes from the radial center of shaft 204, such as axis 220. In other embodiments, mirrors 218 may be mounted on directing module 214. Directing module 214 may rotate transversely about the longitudinal axis of deburring system 200.

Typically, mirrors 216, 218 are positioned about their respective openings 210, 212 to redirect laser beams 202A, 202B to be emitted from deburring system 200 radially from its longitudinal center to hit interior surface 106 at or near the normal of its surface (i.e. at approximately 90 degrees to its surface) as shown per laser beam 202A in FIG. 3B. Mirrors 210, 212 may be covered (not shown) or shielded to protect them from the ambient temperatures and particles in pipe 100.

Mirrors 216 and/or 218 may also be oriented relative to beams 202A, 202B in slightly offset positions, so that one of laser beams 202A, 202B may strike interior surface 106 at an offset angle between approximately 1 degree and 89 degrees from the normal of its surface (i.e. from the radius of pipe 100), as shown per laser beam 202B in FIG. 3B. For example for the two openings 210 shown, mirrors 218(i) and 218(ii) may be provided to each selectively deflect beams 202B(i) and 202B(ii) towards each other relative to the radius from the center axis of system 200. This offset orientation may be used to melt both outer edges of slot 108 on interior surface 104, to create a rounded or smoothed radius of edges on opening 110 for slot 108. In certain configurations, the power of beam 202B(i) and/or beam 202B(ii) and/or the duration of their activation may be modulated to limit or extend the time either of the beams 202B are exposed to a particular location on pipe 100. This modulation may assist in deburring areas having thick and/or many wickers. This modulation may also assist in reducing of heat provided to selected areas on pipe 100, for example the remote opposite interior side of slot 108 when beam 202 is rounding the proximate edge of slot 108. Mirrors 216 and/or 218 may also be positioned to not be in the path of laser beams 202A, 202B. See FIG. 3B for exemplary configurations of mirrors 218(i) and 218(ii). The relative power provided to each or either of beams 202B(i) or 202B(ii) may be modulated so that it has sufficient power to melt its immediate target of wicker 112 and round an edge of the proximate side of opening 110, but not enough power to scorch the interior side of slot 108.

One type of modulation for laser 208 is to pulse its output. When laser 208 provides a pulsed output, then the power of a single laser beam 202A may be distributed among different openings 210/212 at different times, by having a series of internal mirrors (not shown) along the path of laser beam 202 in system 200 that may be deployed/not deployed to direct laser beam 202 to one or more of openings 210/212 at different times. As such, a single laser 208 may provide directed laser beams 202 to different openings 210/212.

Mirrors 216 and 218 may be partially reflective so that some of the light received at the mirrors passes through them. This allows for “beam splitting” for beams 202. FIG. 2D, shows an alternative directing module 214B where laser beam 202C is split into two parts 202C(i) and 202C(ii) by mirror 216B inside module 214B, thereby providing structural protection to mirror 216B. Additional splits can be provided in supplementary stages. In one configuration, the amount of reflectivity may either be not fully reflective or the degree of reflectivity may be adjusted. When mirror 216B is not fully reflective, part 202C(i) of beam 202C passes straight through mirror 216B to opening 210B, thereby directing beam 202C(i) to a first location on interior 104, while part 202C(ii) of beam 202C is reflective per the angle of incidence of beam 202C to mirror 216B along an angle of reflection from mirror 216B. Mirror 216B is directed to have beam 202C(ii) be reflected through opening 212B, thereby directing beam 202C(ii) to a second location on interior 104. Each of beams 202C(i) and (ii) may be themselves split and/or redirected with additional mirrors with their resulting beams directed to other locations on pipe 100. Module 222 may control the angle of mirror 216B and/or its level of reflectiveness (e.g. from approximately 0% to 100%). The angle of mirror 216B may be adjusted to focus the beams on burrs 112 that are located on the longitudinal edges and/or the side edges of openings 110. Additional mirrors 216, 218 may be provided to further direct beam 202C(i) and 202C(ii), as per FIG. 2C. As such, module 214B may provide a configuration that permits deburring system 200 to reduce the number of lasers 206 (perhaps to a single laser 208) that are required to operate. As a further alternative, module 214B may have only openings 212B and mirror 214B may be fixed in position. In another embodiment, multiple mirrors may be provided at various locations in system 200 to deflect/redirect a path of beam 202 at multiple instances.

One or more features of directing module 214/214B may be incorporated into shaft 204. For example in an alternative embodiment, shaft 204 may have mirrors 216B/218B and openings 212B/210B embedded therein and shaft 204 itself may be rotatable about its longitudinal axis within pipe 100.

In one configuration, deburring system 200 has collar 224 which fits around shaft 204. Collar 224 is generally cylindrical in shape and is dimensioned to fit within the interior circumference of pipe 100 and around shaft 204. Collar 224 may extend along the entire length of shaft 204 or along one or more portions of it. Skates 226 are longitudinal blocks, rails or strips of material provided on the exterior surface of collar 224 and are dimensioned so that they fit in the space between pipe 100 and collar 224. Skates 226 provide alignment guides to position shaft 204 to be aligned with the longitudinal axis of pipe 100.

Skates 226 are provided in three equally spaced sets around transport module 206. More or less sets of skates 226 may be provided in other embodiments. Skates 226 may be made of a durable material (e.g. hardened steel) and may be hard or may be compressible, which may assist in fitting deburring system 200 in pipe 100. Alternatively skates 226 may not be provided. In such a configuration, deburring system 200 and its components (such as shaft 204 and collar 224) are shaped and dimensioned to more closely fit (e.g. as a snug fit within pipe 100) within target pipe 100.

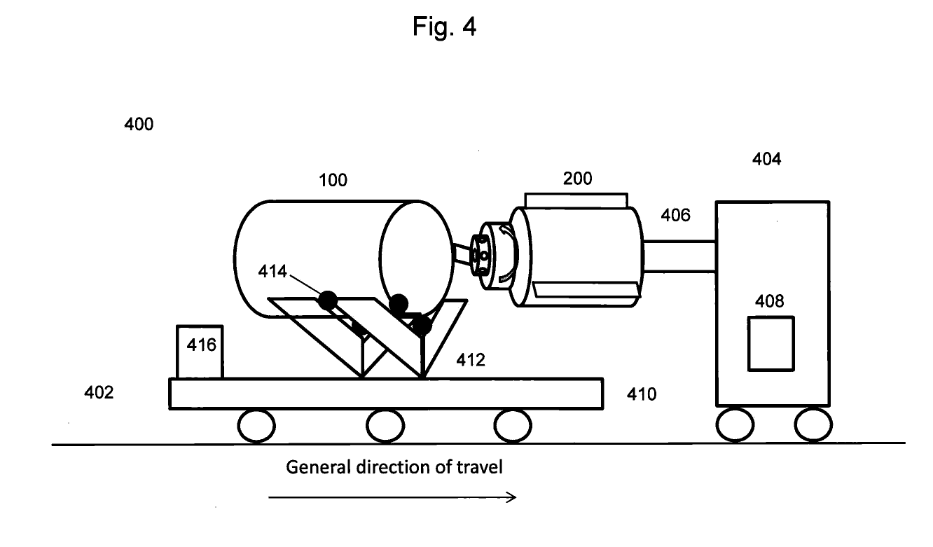

Additional guidance and alignment features may be provided on the radial surface of transport module 224. For example, a set of spring loaded bars (not shown) may be located of the radial surface and may be biased outwardly. When deburring system 200 is inserted into pipe 100, the bars would be compressed inwardly and the bars and the friction provides a snug, but moveable, fit for deburring system 200 in pipe 100. Movement of deburring system 200 within pipe 100 may be provided by an external deployment system (such as deployment system 406, FIG. 4, described later). A secondary collar (not shown) may be provided where a second collar is located in a spaced relationship along shaft 204 to collar 224. Also a transportation system (e.g. rollers, wheels, belts, tracks, etc.) may be provided instead of or in addition to skates 226 to move deburring system 200 within pipe 100.

In one embodiment, shaft 204 is rotatable within collar 224. A movement mechanism for shaft 204 may comprise one or more ring and ball bearing assemblies (not shown), a gear assembly (not shown) or another drive/rotation mechanism located at interface point(s) between the external surface of shaft 204 and the internal surface of collar 224 known to a person of skill in the art. In another embodiment, collar 224 may also rotate transversely about shaft 204 or vice versa. This provides an additional movement system that allows deburring system 200 and its directing module 214 to be rotated transversely about the transverse plane of pipe 100.

Feedback system 228 may be provided in collar 224 or shaft 204 (or generally with deburring system 200) and provides sensors (e.g. cameras, heat sensors, motion sensors, etc.) that provide data on location, temperatures, air pressures and/or images or videos of locations around where deburring system 200 is currently location in pipe 100. This data can be used to locate target burrs 112 for burning by laser beam 202 and to determine whether operating parameters of lasers 206, locations, laser configurations, mirror configurations and/or speeds of movement of deburring system 200 should be changed. An alternative feedback system may take temperature readings around the outside of pipe 100 around the current location of system 200. Temperature readings of the outside of pipe 100 at a location may be used to determine an expected temperature around the inside of pipe 100 at that location. Varying levels for the inside temperature may indicate several conditions, for example, a minimum temperature for burning wickers for a particular pipe configuration, a maximum temperature indicating a potential excessive softening of wall 106 of pipe 100, etc.

Referring to FIG. 2C, part of deburring system 200 is shown, where shaft 204 and internal components thereof are provided. Collar 224 is not shown. For deburring system 200, a cleaning system is provided comprising blower 230 that is located remote from deburring system 200. Cleaning system includes conduits 232 that span within shaft 204 and are connected to ports 234 which are located on the radial surface of shaft 204. Blower 230, which in one embodiment is remote from shaft 204, forces air into conduits 232 that eventually is forced out at ports 234, shown as blown air 236. Blown air 236 may be directed at interior surface 106 to clean it and to remove remnants of burrs 112 after they have been heated by laser beam 202. In one configuration cleaning system carries air and/or water (or a liquid cleaner) through conduits 232. An aiming system (not shown) provides directable nozzles that can be positioned to direct a stream of air/water to a location on interior surface 104 preferably near the location where beam 202 is currently or has recently been focussed. Air 236 may dislodge burrs 112 still attached around opening 110 and may mobilize dislodged burrs and ashes of burrs 112 and direct them away from directing module 214 and/or mirrors 216, 218. The cleaning system may include a vacuum configuration, where blower 230 may be reconfigured to receive air (and any floating debris) from pipe 100 taken in though conduits 232.

Deburring system 200 also may have targeting system 228 which may be used in part to control and direct directing module 214 with mirrors 216, 218, to position deburring system 200 and to aim laser beams 202 to a specific location on interior surface 104. Targeting system 228 may use data from a camera and/or location module to determine where to aim laser beam 202 and whether and where the cleaning system should be used. Targeting system 228 may be responsive to manual movement/direction control signals provided to a control module by an operator of deburring system 200.

One or more features of directing module 214/214B may be incorporated into shaft 204. For example in an alternative embodiment, shaft 204 may have mirrors 216B/218B and openings 212B/210B embedded therein and shaft 204 itself may be rotatable about its longitudinal axis within pipe 100.

In operation in one configuration, deburring system 200 is fed into pipe 100 and is either retracted from it or continues deeper into pipe 100 at a pre-programmed rate of speed. The direction of travel (forward into pipe 100 or backward out of pipe 100) may be changed and adjusted. As such an exemplary movement pattern may have system 200 being fed into pipe 100, partially retracted, then fed deeper into pipe 100. The speed may be determined by the local composition of pipe 100 at a given length being traversed and an expected pattern/density of slots 108 in that length. Deburring system 200 set to be moved along pipe 100 according to the programmed rate of speed. As deburring system 200 is moving along pipe 100 it may also rotate about its longitudinal axis while emitting laser beams 202A, 202B, 202C(i) and 202C(ii) and the angle of mirrors 216, 218 may be adjusted. Rotation may be provided through rotation of one or more of directing module 214 and/or shaft 204. As such, the entire interior circumference (or a predetermined part of it) may be exposed to laser beams 202A, 202B, 202C(i) and 202C(ii) as deburring system 200 moves along that length of pipe 100.

Laser beams 202A, 202B, 202C(i) and 202C(ii) may be pulsed to increase their frequency if a dense section of slots 108 is present along pipe 100 or to reduce their frequency if a sparse section of slots 108 is present along pipe 100. If the radial spacing of slots 108 is known for the pipe where deburring system 200 is currently located, then deburring system 200 may synchronize its lasers beams 202A, 202B, 202C(i) and 202C(ii) and oriented its mirrors 216 and 218 and orient directing module 214 to direct openings 210, 212 and so that laser beams 202A, 202B, 202C(i) and 202C(ii) are activated to heat only locations where openings 110 are expected along the length of pipe 100. Control of these systems may be provided in a computer-based program, described later. This can save energy and deburring time.

It will be appreciated that the components for deburring system 200 described herein may be provided in different arrangements relative to each other while still performing their described functions. Alternatively, components can be combined.

One or more features of collar 224, directing module 214/214B, openings 210/212, cleaning a system and/or a targeting system may be incorporated into shaft 204. For example in an alternative embodiment, shaft 204 may have mirrors 216B/218B and openings 212B/210B embedded therein and shaft 204 itself may be rotatable about its longitudinal axis within pipe 100.

Deburring system 200 for an embodiment has been shown and described as being generally cylindrical in form to assist with its insertion and movement within pipe 100, while allowing movement, positioning and orientation of laser beam 202 within pipe 100. However, other shapes and forms may be provided for one or more components of alternative deburring systems for an embodiment. For deburring system 200 one or more of its components may be made from metal any durable material able to withstand ambient heat, humidity, vibration and other harsh operating conditions in and around pipe 100. Components of system 200, such as shaft 204, may be solid or hollow in parts.

A deburring system may have additional components, such has supplementary deburring system(s) to provide ancillary deburring stage(s) which are provided in system 200 either before or after a laser and directing module 214.

One exemplary supplementary system is a torch head where the torch head provides one or more gas torch nozzles that carry a combustion gas and an oxidizing gas, producing substantially neutral-burning flames at the nozzles. The flame may be directed to interior surface 104 of pipe 100 to burn/melt the burrs.

In a torch head, a series of radial conduits can be provided for conveying, respectively, a combustion gas, a primary oxidizing gas and an auxiliary oxidizing gas from respective sources. The torch head may have multiple gas torch nozzles disposed (preferably, but not necessarily, at uniform spacing) around its circumferential lateral surface, such that when the torch head is passed through the interior of pipe 100, flames from the torch nozzles will be directed toward interior surface 104 and toward burrs that may be present in at openings 110. In one embodiment, one or more of the torch nozzles have a forward cant, so that the flames from these nozzles are directed both radially outward and toward the front of the torch head.

Another exemplary supplementary system is a burnishing system that provides a series of rotating blades and/or brushes outwardly radially disposed about deburring system 200 that scrape interior surface 104 of pipe 100 to physically cut off or remove burrs 112 from openings 110.

One or both of these supplementary systems may be provided in different stages with deburring system 200. The order of appearance of directing module 214 and the supplementary systems along a longitudinal length of deburring system 200 may be in any order to suit a particular implementation. For example, a lead stage (i.e. at the anterior end of shaft 204) may be a torch head, followed by directing module 214, followed by the burnishing system. Other orders may be provided. A cleaning system may be provided at the end of the systems (i.e. at the posterior end of shaft 204). Each of the laser, torch and burnishing modules may have multiple stages (e.g. two or more directing modules 214 for multiple lasers 208, two or more torch heads and/or two or more burnishing systems) located along shaft 204 in different orders.

FIG. 4 shows features of an exemplary transport system 400 for positioning deburring system 200 within pipe 100. Transport system 400 comprises pipe transport system 402 for pipe 100 and laser station 404. In one embodiment, laser station 404 houses laser 208 and blower 230 provide deployment system 406 for deburring system 200. Laser station 404 may be moveable and may be moveable along tracks (not shown). In laser station 404, mount 406 may connect deburring system 200 to station 404. Control system 408 may control movement of laser station 404, rotation of deburring system 200 and lasers 202.

Also, a supplementary blower system may be provided to blow/vacuum an interior of pipe 100. Further still, a supplementary “stinger” system may be provided to mechanically debur the interior of pipe 100. Such supplementary systems may also be track mounted.

Turning now to transport system 402, bed 410 provides a movable base to support pipe 100 as it is being deburred. Bed 410 may be moved in a longitudinal direction (forwards and backwards) along the longitudinal axis of pipe 100. Bed 410 may also be moved in a lateral direction (left and right) along the traverse axis of pipe 100. Bed 410 may be canted up or down along its longitudinal axis and may further be canted left or right along its traverse plane. Support 412 is mounted on bed 410 and is shaped to receive and hold pipe 100 and to expose the interior opening of pipe 100 to deburring system 200. Rollers 414 in support 412 allow pipe 100 to be rotated about its transverse plane (clockwise and counter-clockwise) to allow pipe 100 to be rotated about its traverse plane to turn pipe 100 about deburring system 200 along a current transverse plane of pipe 100. Rollers 414 and support 412 provide structural support for holding pipe 100 and may comprise any suitable material for providing such a structural framework for pipe 100 to bed 410. A clamping or securing system may be provided (not shown) to secure pipe 100 to bed 410. Control module 416 may provide feedback and control systems for bed 410 and rollers 414.

Bed 410 and rollers 414 may be implemented in a gear assembly operatively connected with bed 410 to longitudinally and or rotationally move pipe 100 about deburring system 200. In one embodiment, the gear assembly comprises a rack and worm gear assembly. It will be seen that bed 410 may be moved in a longitudinal direction and/or in a lateral direction while rollers 414 rotate pipe 100. As such, there is a full range of movement for pipe 100 while deburring system 200 is set at a given location. In addition, deburring system 200 may also be moved simultaneously as previously noted to further position deburring system 200 at specific locations and angles relative to the surface of pipe 100.

System 400 may be used to hold pipes 100 having various OD and IDs. For example, most typical pipes may have an OD of between approximately 51 mm (2 inches) and 381 mm (15 inches), with a typical OD of between approximately 102 mm (4 inches) and 244.5 mm (9⅝ inches). A typical thickness for wall 106 may be between approximately 6.4 mm (0.25 inches) and 76.2 mm (3.0 inches) with a typical thickness of about 12.7 mm (0.5 inches). System 400 may have one or more power sources (not shown) for systems 402 and 404.

In an alternative embodiment a more portable deburring system 200 may be provided where a simplified transport system 402 (or no transport system 402) is provided. In that embodiment, system 404 has a frame that extends over pipe 100, which is securely mounted to a solid feature (such as the ground) and system 404 is self-contained to provide movement and alignment systems to move deburring system 200 within pipe 100, which remains stationary or mostly stationary.

Features of an embodiment have described a deburring system that primarily is used to remove artefacts from an interior of a pipe. In alternative embodiments, a system can be provided that travels along an outside of a pipe or other structure and removes burrs from an outside surface of the structure using components as described herein, but oriented and configured to remove such outside burrs.

Control functions for movement of deburring system 200, rotation of directing module 214, mirrors 216 and 218, operation of lasers 208, operation of feedback system 228, cleaning system, laser burning patterns and/or system 400 may be controlled by a control module provided in deburring system 200 or remote from it. The control module may be a microprocessor-based system having a memory device storing program instructions and data accessible by deburring system 200. Commands issued by the control module may be sent to one or more of the components described herein. Commands received by the components are implemented. The components may have electro-mechanical devices and/or servers to implement the commands. For example a command to rotate directing module 214 and mirrors 216, 218 may be implemented by servos associated with those components.

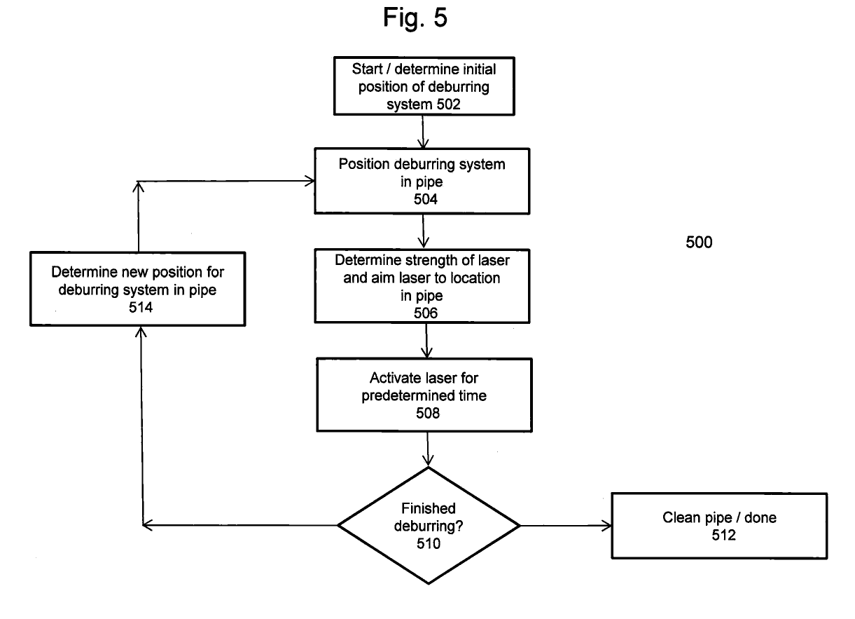

FIG. 5 shows flow chart 500 providing a further aspect of an embodiment for a method of deburring wickers from an interior of a pipe, using a focussed beam of energy, such as a laser. The laser may be mounted in a deburring system (such as deburring system 200 in transport system 400) and the direction of the beam may be controlled by one or more mirrors in the system (such as mirrors 216, 218).

At process 502, the method starts and an initial position for the deburring system within a pipe is determined. As process 504, the deburring system is positioned accordingly. At process 506, a direction for a laser and a strength is determined. At process 508, the laser is activated for a preset amount of time. At process 510, a test is made to determine if deburring is completed. This may be determined by evaluating whether the deburring system has completed a predetermined series of positions and/or laser activations to debur the pipe and/or from feedback data provided from a feedback system (such as feedback system 228). If deburring is complete, then at process 512, the current deburring process ends. Afterwards a subsequent deburring process may be initiated (following one or more processes of flow chart 500) or a clean process may be initiated (following one or more processes of flow chart 500, where cleaning processes are activated instead of a laser). If deburring is not complete, then at process 514, a new position for the deburring system is identified and the process returns to process 504. In other embodiments, these processes may be executed in different orders and some processes may be combined or skipped. These processes may be implemented in a software application controlling one or more features of a deburring system (e.g. laser and/or positional control).

As used herein, the wording “and/or” is intended to represent an inclusive-or. That is, “X and/or Y” is intended to mean X or Y or both.

In this disclosure, all measurements, dimensions, tolerances, operating ranges and thresholds are provided as exemplary and approximates value (for example, when the adjustment values is qualified with the word “about”), a range of values will be understood to be valid for that value. For example, for an adjustment value stated as an approximate value, a range of about 25% larger and 25% smaller than the stated value may be used. Thresholds, values, measurements and dimensions of features are illustrative of embodiments and are not limiting unless noted. Types of materials described are exemplary and not limiting. Purposes for the pipes are exemplary and not limiting.

The present disclosure is defined by the claims appended hereto, with the foregoing description being merely illustrative of embodiments of the disclosure. Those of ordinary skill may envisage certain modifications to the foregoing embodiments which, although not explicitly discussed herein, do not depart from the scope of the disclosure, as defined by the appended claims.

1. A deburring system for removing burrs from a surface of a pipe, the deburring system comprising:
a shaft having an anterior end;
a conduit contained in the shaft for carrying a laser beam generated from a laser; and
a directing module to direct the laser beam emanating from the conduit radially from the shaft to the surface of the pipe,
wherein
the deburring system is shaped to fit inside the pipe.

2. The deburring system for removing burrs from a surface of a pipe as claimed in claim 1, further comprising:
a collar located around the shaft to allow the shaft to rotate about a longitudinal axis of the collar relative to the collar.

3. The deburring system for removing burrs from a surface of a pipe as claimed in claim 2, wherein the collar comprises:
a set of skates located on a radial surface of the collar.

4. The deburring system for removing burrs from a surface of a pipe as claimed in claim 1, wherein:
the directing module is incorporated into the shaft.

5. The deburring system for removing burrs from a surface of a pipe as claimed in claim 1, wherein the directing module further comprises:
a first mirror to redirect a path of the laser beam emitted from the deburring system.

6. The deburring system for removing burrs from a surface of a pipe as claimed in claim 5, wherein the first mirror:
splits the laser beam into a plurality of laser beams; and
each of the plurality of laser beams is directed to different locations on the surface of the pipe.

7. The deburring system for removing burrs from a surface of a pipe as claimed in claim 5, wherein the first mirror:
is angled to redirect the path of the laser beam to contact an interior wall of the pipe at a first angle between approximately 1 and 45 degrees from the radius of the pipe.

8. The deburring system for removing burrs from a surface of a pipe as claimed in claim 5, further comprising:
a second mirror to redirect a path of a second laser beam emitted from the deburring system to contact the interior wall of the pipe at a second angle between approximately 1 and 45 degrees from the radius of the pipe.

9. The deburring system for removing burrs from a surface of a pipe as claimed in claim 8, wherein:
the first and second mirrors are directed to locate the first and second lasers to simultaneously debur different sides of an opening in the interior wall of the pipe.

10. The deburring system for removing burrs from a surface of a pipe as claimed in claim 1, further comprising:
a control module to modulate the power and duration of the laser beam.

11. The deburring system for removing burrs from a surface of a pipe as claimed in claim 10, wherein:
the control module is responsive to data relating to a temperature of the pipe to modulate the power and duration of the laser beam.

12. The deburring system for removing burrs from a surface of a pipe as claimed in claim 11, wherein:
the temperature relates to a temperature on an exterior surface of the pipe.

13. The deburring system for removing burrs from a surface of a pipe as claimed in claim 11, wherein:
the temperature relates to a temperature in an interior of the pipe.

14. The deburring system for removing burrs from a surface of a pipe as claimed in claim 1, further comprising:
a cleaning system attached to a blower to direct air out of a port in the deburring system to remove remnants of the burrs from the surface of the pipe.

15. The deburring system for removing burrs from a surface of a pipe as claimed in claim 1, further comprising:
a feedback system to provide data on a location and temperatures within the pipe at a current location deburring system within the pipe.

16. The deburring system for removing burrs from a surface of a pipe as claimed in claim 1, further comprising:
a control system to activation commands to the laser and orientation commands to the directing module following an expected pattern of slots for a location within the pipe.

17. A method of removing burrs from a surface of a pipe, the method comprising:
positioning a deburring system having a laser at a first location within the pipe;
positioning a directing module to direct a laser beam from the laser at a second location on an interior wall of the pipe;
activating the laser for a preset amount of time; and
positioning the deburring system at a third location within the pipe,
wherein
the deburring system has
a shaft having an anterior end; and
a conduit contained in the shaft for carrying the laser beam generated from the laser;
and
the directing module directs the laser beam emanating from the conduit radially from the shaft to the surface of the pipe.
